(19) United States
(12) Patent Application Publication
(10) Pub. No.: US 2016/0330103 A1
(43) Pub. Date: Nov. 10, 2016

(54) VIDEO ON DEMAND CONTROL METHOD AND CONTROL DEVICE USING THE METHOD

(71) Applicant: HON HAI PRECISION INDUSTRY CO., LTD., New Taipei (TW)

(72) Inventor: HO-JEN LAI, New Taipei (TW)

(21) Appl. No.: 15/096,280

(22) Filed: Apr. 12, 2016

(30) Foreign Application Priority Data
May 7, 2015 (TW) 104114511

(51) Int. Cl. H04L 12/729; H04L 12/721

(52) U.S. Cl. CPC H04L 45/125; H04L 45/38

(57) ABSTRACT

In a video on demand (VOD) method and control device using the method, a request for establishing a network topology from the media server is received and the network topology is established. Bandwidth values of several possible transmission routes in the network topology are calculated. A first transmission route with maximum bandwidth is selected and the size of a data cache memory for the client is determined to be smaller or greater than a default value. When the data cache memory size is calculated to be greater than a default value a second transmission route is selected from the transmission routes to effectively transmit more data or faster data. Less network bandwidth is wasted and network efficiency is improved, also ensuring that video of the client plays back smoothly.

### CROSS-REFERENCE TO RELATED APPLICATIONS

This application claims priority to Taiwanese Patent Application No. 104114511 filed on May 7, 2015, the contents of which are incorporated by reference herein.

### FIELD

The subject matter herein generally relates to video communications, in particular to video on demand (VOD) service control based on Software Defined Networking (SDN).

### BACKGROUND

A video on demand (VOD) service is an interactive video system which provides on demand programme according to user's need. Video on demand (VOD) systems allow users to select and watch/listen to interactive video or audio content when they choose to, rather than having to watch at a specific time. IPTV technology is often used to bring video on demand to televisions and personal computers. Currently, a data flow of a VOD service is transmitted via a fixed route with fixed bandwidth. However, where the available bandwidth is less, more time is needed for users to receive the data flow of the VOD service, thus affecting user experience. In contrast, transmitting a small amount of video data through large bandwidth is wasted, which decreases network transmission efficiency.

### BRIEF DESCRIPTION OF THE DRAWINGS

Implementations of the present technology will now be described, by way of example only, with reference to the attached figures, wherein:

FIG. 1 illustrates a diagrammatic view of an embodiment of a network topology for a control device.

FIG. 2 illustrates a block diagram of an embodiment of function modules of the the control device of FIG. 1.

FIG. 3 illustrates a block diagram of another embodiment of function modules of the control device of FIG. 1.

FIG. 4 illustrates a flowchart of an embodiment of a video on demand control method for selecting a transmission route for media server data to the client.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

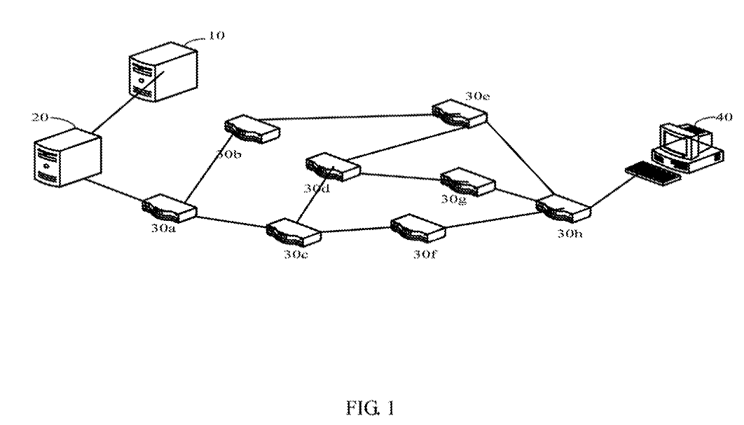

FIG. 1 illustrates one embodiment of a network topology for a control device (control device 10) for providing media on demand services. In the embodiment, the network topology includes, but is not limited to, a control device 10, a media server 20 providing media services, multiple switches 30a-30h, and a client 40. In the embodiment, the network topology is Software Defined Networking (SDN) architecture, the control device 10 is an SDN controller, and the switches 30a-30h are SDN switches. The client 40 may request the media server 20 to initiate and supply video on demand (VOD) services.

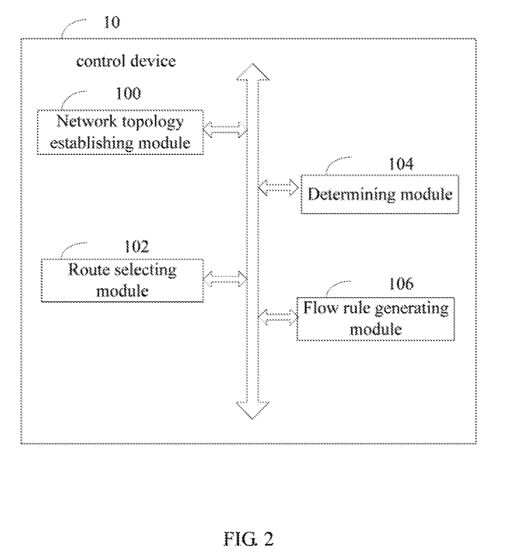

FIG. 2 illustrates one embodiment of function modules of the control device 10. The control device 10 includes a network topology establishing module 100, a route selecting module 102, a flow rule generating module 104, and a determining module 106.

The network topology establishing module 100 establishes a network topology according to a request from the media server 20. The client 40 requests the media server 20 to initiate a VOD service through a predetermined network route. When receiving the request from the client 40, the media server 20 sends a request to the control device 10 for establishing a network topology. In the embodiment, the request for establishing the network topology from the media server 20 comprises an Internet Protocol (IP) address and a network port of the media server 20, an IP address of the client 40, and a network port and minimum required bandwidth of a network route to the client 40. The control device 10 establishes the network topology between the media server 20 and the client 40 according to the received request.

The route selecting module 102 calculates bandwidth values of each of transmission routes in the network topology and selects a first transmission route with the maximum bandwidth value to transmit media data from the media server 20. In the embodiment, multiple transmission routes are provided in the network topology, such as 30a-30b-30e-30h, 30a-30c-30d-30g-30h, 30a-30c-30f-30h, and 30a-30c-30d-30e-30h, as shown in FIG. 1. Data transmission speed of each transmission route is different due to bandwidth variations of each transmission route. After the network topology is established, the route selecting module 102 selects the first transmission route to transmit media data of the media server 20 to the client 40.

The flow rule generating module 104 generates a first flow rule corresponding to the first transmission route for multiple first switches installed in the first transmission route, and transmits the first flow rule to each of the first switches. It is noted that SDN switches itself can only implement data forwarding according to flow rules assigned by an SDN controller, which is the control device 10. In an embodiment, when the flow rule generating module 104 selects the transmission route 30a-30c-30f-30h, the switches 30a, 30c, 30f, and 30h need to know their corresponding flow rules to implement data forwarding. In the embodiment, when the switches 30a, 30c, 30f and 30h in the first transmission route obtain corresponding flow rules, they transmit media data of the media server 20 to the client 40 requesting the VOD service.

The determining module 106 determines whether the amount of a data cache memory for the client 40 is greater than a default value. If the amount of the data cache memory of the client 40 is greater than the default value, the route selecting module 102 selects a second transmission route from the transmission routes to transmit the media data of the media server 20 to the client 40. Furthermore, the bandwidth value of the second transmission route cannot be less than the data playback speed value of the client 40. In the embodiment, the default value is calculated by a formula that A multiplies by B, where A is the data playback speed value of the client 40 and B is a user-expected playback time for the amount of the data cache memory. The user-expected playback time for the data cache memory can be user-defined. The determining module 106 determines whether the amount of the data cache memory for the client 40 is greater than the default value according to a time value of the media server 20 transmitting the media data. More specifically, the amount of the data cache memory for the client 40 is calculated to be greater than the default value if the time value of the media server 20 transmitting the media data meets formula N. The formula N is presented as follows:

If the time value of the media server 20 transmitting the media data>(the data playback speed value of the client 40*the user-expected time value for the amount of the data cache memory)/(the value of the speed of the media server 20 transmitting data−the value of the data playback speed of the client 40), the determining module 106 determines that the amount of the data cache memory for the client 40 exceeds the default value.

For example, if the speed value of the media server 20 transmitting data is 5 million bits per second (5 Mbps), the value of data playback speed of the client 40 is 3 Mbps, and the user-expected time value for the amount of the data cache memory is 10 seconds, we can calculate the time value of the media server 20 transmitting the media data as the formula N, and (3 Mbps*10 seconds)/(5 Mbps−3 Mbps) is equal to 15 seconds, so while the media server 20 transmits the media data by more than 15 seconds, the determining module 106 determines that the amount of the data cache memory for the client 40 exceeds the default value.

The flow rule generating module 104 generates a second flow rule corresponding to the second transmission route for multiple second switches installed in the second transmission route. After selecting the second transmission route, the second flow rule is transmitted to each of corresponding second switches, such as the switches 30a, 30b, 30e, 30h in the second transmission route 30a-30b-30e-30h. After that, the route selecting module 102 vacates the first flow rule. In the embodiment, the media server 20 transmits media data through the second transmission route when the second switches receives the second flow rule from the control device 10.

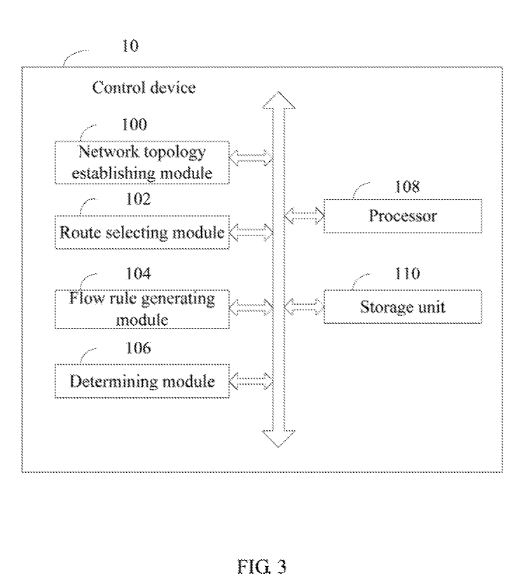

FIG. 3 illustrates a block diagram of another embodiment of function modules of the control device 10. The control device 10 includes a network topology establishing module 100, a route selecting module 102, a flow rule generating module 104, a determining module 106, a storage unit 110, and processor 108. The one or more function modules can include computerized code in the form of one or more programs that are stored in the storage unit 110, and executed by the processor 108 to provide functions of the control device 10. The storage unit 110 can be a dedicated memory, such as an EPROM or a flash memory.

By executing one or more function modules in FIG. 2 or FIG. 3, the client 40 ensures that the media data is played smoothly because of the amount of the data cache memory. Meanwhile, the network efficiency is improved by transmission route adjustment.

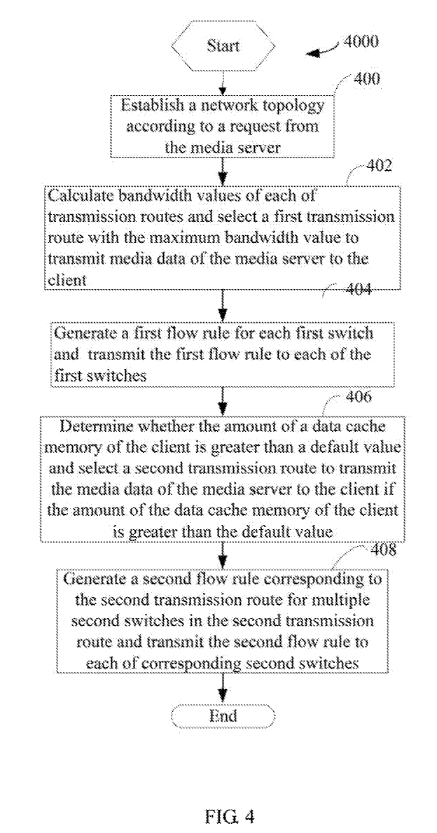

FIG. 4 illustrates a flowchart of a method 4000 for selecting a transmission route to transmit data of the media server 20 to the client 40, and the function modules 100-106 as FIG. 2 illustrates or the function modules 100-110 as FIG. 3 illustrates are executed by the processor 108 to realize the method. The method 4000 is provided by way of example, as there are a variety of ways to carry out the method. The method 4000 described below can be carried out using the configurations illustrated in FIG. 4, for example, and various elements of these figures are referenced in explaining the method 4000. Each block shown in FIG. 4 represents one or more processes, methods, or subroutines, carried out in the exemplary method 4000. Additionally, the illustrated order of blocks is by example only and the order of the blocks can change. The method 4000 can begin at block 400.

At block 400, the network topology establishing module 100 establishes a network topology according to a request from the media server 20. The client 40 requests the media server 20 to initiate a VOD service through a predetermined network route. When receiving the request from the client 40, the media server 20 sends a request to the control device 10 for establishing a network topology. In the embodiment, the request for establishing the network topology from the media server 20 comprises an Internet Protocol (IP) address and a network port of the media server 20, an IP address of the client 40, and a network port and minimum required bandwidth of a network route to the client 40. The control device 10 establishes the network topology between the media server 20 and the client 40 according to the received request for establishing the network topology.

At block 402, the route selecting module 102 calculates bandwidth values of each of transmission routes in the network topology and selects a first transmission route with the maximum bandwidth value from the transmission routes to transmit media data of the media server 20 to the client 40. In the embodiment, multiple transmission routes are provided in the network topology, such as 30a-30b-30e-30h, 30a-30c-30d-30g-30h, 30a-30c-30f-30h and 30a-30c-30d-30e-30h, as showed in FIG. 1. Data transmission speeds of each of the transmission routes are different due to bandwidth variations of each of the transmission routes. After the network topology is established, the route selecting module 102 selects the first transmission route to transmit media data of the media server 20 to the client 40.

At block 404, the flow rule generating module 104 generates a first flow rule corresponding to the first transmission route for each first switch installed in the first transmission route, and transmits the first flow rule to each of the first switches. It is noted that SDN switches itself can only implement data forwarding according to flow rules assigned by an SDN controller, the control device 10. In an embodiment, when the flow rule generating module 104 selects the transmission route 30a-30c-30f-30h, the switches 30a, 30c, 30f and 30h need to know their corresponding flow rules to implement data forwarding. In the embodiment, when the switches 30a, 30c, 30f and 30h in the first transmission route obtain corresponding flow rules, they transmit media data of the media server 20 to the client 40 requesting the VOD service.

At block 406, the determining module 106 determines whether the amount of a data cache memory for the client 40 is greater than a default value. The route selecting module 102 selects a second transmission route from the transmission routes to transmit the media data of the media server 20 to the client 40 if the amount of the data cache memory of the client 40 is greater than the default value. Furthermore, the bandwidth value of the second transmission route can not be less than the data playback speed value of the client 40. In the embodiment, the default value is calculated by a formula that A multiplies by B, where A is the data playback speed value of the client 40 and B is a user-expected playback time for the amount of the data cache memory. The user-expected playback time for the amount of the data cache memory can be user-defined. The determining module 106 determines whether the amount of the data cache memory for the client 40 is greater than the default value according to a time value of the media server 20 transmitting the media data. More specifically, the amount of the data cache memory for the client 40 is greater than the default value if the time value of the media server 20 transmitting the media data meets a formula N. The formula N is presented as follows:

If the time value of the media server 20 transmitting the media data>(the data playback speed value of the client 40*the user-expected time value for the amount of the data cache memory)/(the value of the speed of the media server 20 transmitting data−the value of the speed of the client 40 playback data), the determining module 106 determines that the amount of the data cache memory for the client 40 exceeds the default value.

For example, if the speed value of the media server 20 transmitting data is 5 million bits per second (Mbps), the speed value of the client 40 playback data is 3 Mbps, and the user-expected time value for the amount of the data cache memory is 10 seconds, we can calculate the time value of the media server 20 transmitting the media data as the formula N, and (3 Mbps*10 seconds)/(5 Mbps−3 Mbps) is equal to 15 seconds, so while the media server 20 transmits the media data by more than 15 seconds, the determining module 106 determines that the amount of the data cache memory for the client 40 exceeds the default value.

At block 408, the flow rule generating module 104 generates a second flow rule corresponding to the second transmission route for multiple second switches installed in the second transmission route, and, after selecting the second transmission route, transmits the second flow rule to each of corresponding second switches, such as the switches 30a, 30b, 30e, 30h in the second transmission route 30a-30b-30e-30h. After that, the route selecting module 102 vacates the first flow rule. In the embodiment, the media server 20 transmits the media data through the second transmission route when the second switches receives the second flow rule from the control device 10.

By executing blocks above, the client 40 ensures the media data is played smoothly because of the amount of the data cache memory. Meanwhile, the network efficiency is improved by transmission route adjustment.

The embodiments shown and described above are only examples. Many details are often found in the art such as the other features of a device and method for selecting a transmission route to transmit data of the media server 20 to the client 40. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A video on demand (VOD) control method applied to at least one control device, wherein the control device is electronically connected to at least one media server, and the media server provides at least one client with a VOD service, the method comprising:
receiving a request for establishing a network topology from one of the at least one media server;
establishing the network topology according to the received request;
calculating bandwidth values of everyone of transmission routes in the network topology;
selecting a first transmission route with the maximum bandwidth value from the transmission routes to transmit data of the media server to the client;
determining whether an amount of a data cache memory for the client is greater than a default value; and
selecting, when the amount of the data cache memory is greater than the default value, a second transmission route from the transmission routes to transmit the data of the media server to the client.

2. The method as claimed in claim 1, wherein the bandwidth value of the second transmission route is greater than a data playback speed value of the client.

3. The method as claimed in claim 1, wherein the default value is equal to a data Page 13 of 18 playback speed value of the client multiplying a user-expected playback time for the amount of the data cache memory.

4. The method as claimed in claim 1, wherein the request for establishing the network topology comprises an internet protocol address and a port number of the media server, an internet protocol address and a port number of the client, and a minimum bandwidth value required for the VOD.

5. The method as claimed in claim 1, wherein the network topology is located between the media server and the client, and multiple switches are installed in each of the transmission routes of the network topology.

6. The method as claimed in claim 5, wherein the switches are software-defined networking (SDN) switches, and the control device is SDN controller.

7. The method as claimed in claim 5, wherein the step of selecting the first transmission route comprises:
generating a first flow rule corresponding to the first transmission route for multiple first switches installed in the first transmission route; and
transmitting the data of the media server according to the first flow rule via the first switches.

8. The method as claimed in claim 5, wherein the step of selecting the second transmission route comprises:
generating a second flow rule corresponding to the second transmission route for multiple second switches installed in the second transmission route; and
transmitting the data of the media server according to the second flow rule via the second switches.

9. A control device for being electronically connected to at least one media server, wherein the media server provides at least one client with a video on demand (VOD) service, the control device comprising:
at least one processor;
a database;
a storage unit; and
one or more programs that are stored in the storage unit and executed by the at least one processor, the one or more programs comprising instructions for:
receiving a request for establishing a network topology from one of the at least one media server;
establishing the network topology according to the received request;
calculating bandwidth values of everyone of transmission routes in the network topology;
selecting a first transmission route with the maximum bandwidth value from the transmission routes to transmit data of the media server to the client;
determining whether an amount of a data cache memory for the client is greater than a default value; and
selecting, when the amount of the data cache memory is greater than the default value, a second transmission route from the transmission routes to transmit the data of the media server to the client.

10. The control device as claimed in claim 9, wherein the bandwidth value of the second transmission route is greater than a data playback speed value of the client.

11. The control device as claimed in claim 9, wherein the default value is equal to a data playback speed value of the client multiplying a user-expected playback time for the amount of the data cache memory.

12. The control device as claimed in claim 9, wherein the request for establishing the network topology comprises an internet protocol address and a port number of the media server, an internet protocol address and a port number of the client, and a minimum bandwidth value required for the VOD.

13. The control device as claimed in claim 9, wherein the network topology is located Page 16 of 18 between the media server and the client, and multiple switches are installed in each of the transmission routes of the network topology.

14. The control device as claimed in claim 13, wherein the switches are software-defined networking (SDN) switches, and the control device is SDN controller.

15. The control device as claimed in claim 13, wherein the one or more programs further comprises instructions for:
generating a first flow rule corresponding to the first transmission route for multiple first switches installed in the first transmission route; and
transmitting the data of the media server according to the first flow rule via the first switches.

16. The control device as claimed in claim 13, wherein the one or more programs further comprises instructions for:
generating a second flow rule corresponding to the second transmission route for multiple second switches installed in the second transmission route; and
transmitting the data of the media server according to the second flow rule via the second switches.
